(19) United States
(12) Patent Application Publication
(10) Pub. No.: US 2026/0042606 A1
(43) Pub. Date: Feb. 12, 2026

(54) TRANSPORT ROBOT AND METHOD FOR CONTROLLING ROBOT TO RETRIEVE GOODS

(71) Applicant: HAI ROBOTICS CO., LTD., Shenzhen (CN)

(72) Inventors: Kai CHEN, Shenzhen (CN); Xiaolong LI, Shenzhen (CN); Boqiang QIN, Shenzhen (CN); Dairong CHEN, Shenzhen (CN)

(21) Appl. No.: 18/897,656

(22) Filed: Sep. 26, 2024

Related U.S. Application Data
(63) Continuation of application No. PCT/CN2023/115088, filed on Aug. 25, 2023.

(30) Foreign Application Priority Data
Sep. 2, 2022 (CN) 202211070015.6

(51) Int. Cl. B65G 1/04; B25J 5/00

(52) U.S. Cl. CPC B65G 1/0414; B25J 5/007

(57) ABSTRACT

A transport robot includes a movable base, a frame arranged on the movable base, a first arm assembly arranged on the frame and a second arm assembly arranged on the frame and located above the first arm assembly. The first arm assembly is movable vertically along the frame and retractable horizontally relative to the frame, and the first arm assembly is configured to carry a first container. The second arm assembly is movable vertically along the frame and retractable horizontally relative to the frame, and the second arm assembly is configured to move a second container.

### CROSS-REFERENCES

This application is a continuation of International Patent Application No. PCT/CN2023/115088, filed Aug. 25, 2023, which claims priority to and the benefit of Chinese Patent Application No. 202211070015.6, filed Sep. 2, 2022, the entireties of which are hereby incorporated herein by reference.

### TECHNICAL FIELD

The present disclosure relates to the technical field of goods retrieving and placing, and in particular, to a transport robot and a method for controlling a robot to retrieve goods.

### BACKGROUND OF THE INVENTION

At present, the method for retrieving goods is different for multi-level retrieving and placing operations and single-level retrieving and placing operations. The method for multi-level retrieving and placing mainly includes clamp-type goods retrieving by a robot: a fork of the robot extends to a position near goods, and further, fork arms of the fork extend to clamp the goods at a top level among a plurality of stacked goods and put the goods on a fork tray, to complete goods retrieving. The single-level retrieving and placing mainly includes pull-type goods retrieving by a robot: a finger is attached to each fork arm of a fork of the robot, fork arms extend over a back end of a container/goods to be taken, the fingers of the fork arms lay down, and hook the back end of the container/goods, to pull out one container/goods to be taken, so as to complete overall retrieving and placing of goods. The single-level retrieving and placing further has a suction-type retrieving and placing method or the like.

The existing two methods for retrieving and placing of goods have the following defects:
1. It is not possible to retrieve and place multi-level stacked containers/goods, such as storage containers/shoe boxes, storage containers/shoe boxes of only one level or a top level of stacked storage containers/shoe boxes can be retrieved and placed, and it is not possible to randomly retrieve and place a container at or below a middle level of stacked storage containers/shoe boxes.
2. Since the storage containers/shoe boxes of only one level or the top level can be retrieved, the storage containers/shoe boxes cannot be stacked or a stack is not high, resulting in a waste of a vertical space on a rack.
3. In order to facilitate goods retrieving, the rack needs to be designed in multiple levels. The multi-level design may increase the cost of beams and shelf boards, and the shelf materials are wasteful and costly.

### SUMMARY OF THE INVENTION

A fork for a transport robot of the present disclosure includes a fork body, a tray, a first fork arm, and a second fork arm. The tray, the first fork arm and a second fork arm are arranged on one side of the fork body from bottom to top. The tray, the first fork arm, and the second fork arm are separately retractable relative to the fork body in a horizontal direction. Retractable directions of the tray, the first fork arm, and the second fork arm are perpendicular to a height direction of the fork body.

In some embodiments, the first fork arm includes two oppositely arranged first retractable arms. The two first retractable arms are capable of opening or closing horizontally in a direction perpendicular to the retractable direction to clamp goods.

In some embodiments, the second fork arm comprises two oppositely arranged second retractable arms. The two second retractable arms are capable of opening or closing horizontally in a direction perpendicular to the retractable direction to clamp goods.

The present disclosure provides a transport robot, including a movable base, a storage shelf, and a fork according to any one of the items mentioned above. The storage shelf is vertically arranged on the movable base, and the fork is arranged on one side of the storage shelf and is capable of moving up and down along a height of the storage shelf.

In some embodiments, the tray includes a first supporting plate and a second supporting plate, one end of the first supporting plate is connected to the fork body, and the second supporting plate is movably disposed on the first supporting plate and is capable of moving relative to the first supporting plate in the horizontal direction.

The present disclosure further provides a method for retrieving goods, applicable to a transport robot, including retrieving a target goods stacked at a middle or lower level from a fixed shelf. The retrieving the target goods stacked at a middle or lower level from a fixed shelf includes the following operations:
S1.1: Before the transport robot moves to the fixed shelf, a fork on the transport robot moves to a height of a target goods.
S1.2: A second fork arm on the fork extends to clamp goods stacked on the target goods and lifts the goods to separate the goods from contact with the first target goods.
S1.3: A first fork arm and a tray on the fork extend separately, the first fork arm clamps the target goods, and the tray extends to abut against an object under the target goods.
S1.4: The first fork arm and tray retract separately, to take the target goods out of the fixed shelf and place the target goods in the fork.
S1.5: The fork descends, and the second fork arm retracts after lowering and placing the clamped and held goods.

In some embodiments, in step S1.2, after the second fork arm clamps the goods, the fork moves upwards along a height of the storage shelf of the transport robot and drives the goods clamped by the second fork arm to move upwards to separate the goods from contact with the target goods.

In some embodiments, a distance by which the fork moves upwards is less than a height of the target goods, so that after the second fork arm clamps the goods to separate the goods contact with the target goods, the target goods is still within a clamping area of the first fork arm.

In some embodiments, in step S1.3, when the target goods is stacked in the middle, the tray extends and abuts against another goods below the target goods. When the target goods is stacked at a lower level, the tray extends and abuts against a partition board of the fixed shelf below the target goods.

In some embodiments, in step S1.5, after the fork descends and drives the second fork arm to descend the goods clamped by the fork to an original position of the target goods on the fixed shelf, the second fork arm releases clamping of the goods and retracts.

In some embodiments, the goods retrieving method for the transport robot further includes retrieving a target goods stacked at an upper level of the fixed shelf. The retrieving a target goods stacked at an upper level of the fixed shelf includes the following operations:
S2.1: Before a fixed shelf, a fork for a transport robot moves to a height of a target goods.
S2.2: A first fork arm and a tray on the fork extend separately, the first fork arm clamps the target goods, the tray extends and abuts against another goods below the target goods.
S2.3: The first fork arm and tray retract separately, to take the target goods out of the fixed shelf and place the target goods in the fork.

The present disclosure has the following beneficial effects: In the fork for the transport robot, by disposing two fork arms up and down, the fork arms can extend and retract independently, so that not only goods at a top level of multi-level stacked goods on a shelf can be taken, but also goods at a middle or lower level of the shelf can be taken, which can promote multi-level stacking of goods on the shelf and make full use of the vertical space of the shelf, thereby greatly reducing the waste of space and the increase of costs during the use of multi-level shelves.

This application provides a fork for a transport robot, the fork includes: a fork body, a tray, a first fork arm arranged on the fork body, and a second fork arm arranged on the fork body. The first fork arm is located above the tray and is retractable relative to the fork body, and the first fork arm is configured to carry goods. The second fork arm is located above the first fork arm and is retractable relative to the fork body, and the second fork arm is configured to carry goods. Retractable directions of the first fork arm and the second fork arm are the same.

In some embodiments, the tray, the first fork arm, and the second fork arm are sequentially arranged on the fork body from bottom to top in a vertical direction, and the retractable directions of the first fork arm and the second fork arm are a first horizontal direction.

In some embodiments, the first fork arm includes two oppositely arranged first retractable arms. The two first retractable arms are capable of opening or closing in a second horizontal direction, to release or clamp and hold goods. The second horizontal direction is perpendicular to the first horizontal direction. Alternatively, a pull rod assembly is provided at one end, of each first retractable arm, away from the fork body, and the pull rod assembly is configured to pull goods onto the tray.

In some embodiments, the second fork arm includes two oppositely arranged second retractable arm. The two second retractable arms are capable of opening or closing in a second horizontal direction, to release or clamp and hold goods. The second horizontal direction is perpendicular to the first horizontal direction.

In some embodiments, the second fork arm is configured to carry goods stacked on the target goods, to separate the goods from contact with the target goods. The first fork arm is configured to carry the target goods onto the tray after the second fork arm separates the goods on the target goods from contact with the target goods.

In some embodiments, the tray is retractably connected to the fork body, and a retractable direction of the tray and the retractable direction of the first fork arm are the same.

In some embodiments, the tray includes a first supporting plate and a second supporting plate, one end of the first supporting plate is connected to the fork body, and the second supporting plate is movably disposed on the first supporting plate and is capable of moving relative to the first supporting plate in the horizontal direction.

This application further provides a transport robot, including a movable base, a storage shelf, and the fork, where the storage shelf is vertically arranged on the movable base, and the fork is arranged on one side of the storage shelf and is capable of moving up and down along a height of the storage shelf.

This application further provides a method for retrieving goods, the method is applicable by a transport robot. The transport robot includes a movable base, a storage shelf disposed on the movable base, and a fork disposed on the storage shelf. The fork includes a fork body, a tray, a first fork arm, and a second fork arm. The tray, the fist fork arm and the second fork arm are arranged on the fork body from bottom to top in a vertical direction. The method includes: before the transport robot moves to a fixed shelf, the fork moves to a height of a first target goods, where the first target goods is on the fixed shelf and stacked at a middle or lower level; the second fork arm extends, and clamps the goods stacked on the first target goods, and the second fork arm rises to lift the goods such that the goods is separated from contact with the first target goods; the first fork arm extends and engages with the first target goods; the first fork arm retracts, to take the first target goods out of the fixed shelf and place the first target goods on the tray; and the fork descending, and the second fork arm retracts after lowers and places the clamped and held goods.

In some embodiments, the second fork arm extends and clamps the goods stacked on the first target goods, the second fork arm rises to lift the goods such that the goods is separated from contact with the first target goods. After the second fork arm clamps the goods, the fork moves upwards along a height of the storage shelf of the transport robot and drives the goods clamped by the second fork arm to move upwards to be separated from contact with the first target goods.

In some embodiments, a distance by which the fork moves upwards is less than the height of the first target goods, so that after the second fork arm clamps the goods to separate the goods form contact with the first target goods, the first target goods is still within a clamping and holding area of the first fork arm.

In some embodiments, the first fork arm is a clamp-type fork arm, and in the step of extending the first fork arm to engage with the first target goods, the first fork arm clamps the first target goods.

In some embodiments, the step of extending the first fork arm further includes: the tray extending relative to the fork body.

In some embodiments, when the first target goods is stacked in the middle, the tray extends and abuts against another goods under the first target goods; and when the first target goods is stacked at a lower level, the tray extends and abuts against a partition board of the fixed shelf below the first target goods.

In some embodiments, in the step of descending of the fork and retracting of the second fork arm after lowering and placing the clamped and held goods, after the fork descends and drives the second fork arm to descend the goods clamped by the fork to an original position of the first target goods on the fixed shelf, the second fork arm releases clamping of the goods and retracts.

In some embodiments, the method further includes: before moving to a fixed shelf, a fork moves to a height of a second target goods, where the second target goods are on the fixed shelf and stacked at an upper level. The first fork arm extends and clamps the second target goods; and the first fork arm retracts, to take the second target goods out of the fixed shelf and place the second target goods on the tray.

### BRIEF DESCRIPTION OF DRAWINGS

One or more embodiments are exemplarily described with reference to the corresponding figures in the accompanying drawings, and the descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a schematic structural diagram of a transport robot according to an embodiment of the present disclosure;

FIG. 2 is a schematic structural diagram viewed from a side of a fork in a transport robot according to an embodiment of the present disclosure;

FIG. 2a is a top view of a firs arm assembly of the transport robot according to an embodiment of the present disclosure, and showing the rod is in a first state;

FIG. 2b is a top view of a firs arm assembly of the transport robot according to an embodiment of the present disclosure, and showing the rod is in a second state;

FIG. 2c is a top view of a second arm assembly of the transport robot according to an embodiment of the present disclosure;

FIG. 3a is a schematic structural diagram of a first fork arm and a second fork arm on the fork shown in FIG. 2;

FIG. 3b is a side view of a tray of the transport robot according to an embodiment of the present disclosure;

FIG. 4 is a top view of the fork shown in FIG. 3a;

FIG. 5a-5g are schematic diagrams of a goods retrieving process of retrieving a target goods stacked at a middle level from a fixed shelf by a transport robot of the present disclosure;

FIG. 6a-6b are schematic diagrams of a goods retrieving process of retrieving a target goods stacked at an upper level from a fixed shelf by a transport robot of the present disclosure;

FIG. 7 is a schematic flowchart of a method for retrieving goods according to an embodiment of the present disclosure; and

FIG. 8 is a schematic flowchart of a method for controlling a robot to retrieve goods according to an embodiment of the present disclosure.

### DETAILED DESCRIPTION

The following describes this application in detail with reference to specific embodiments. The following embodiments help a person skilled in the art to further understand this application, but do not limit this application in any form. It is to be noted that for a person of ordinary skill in the art, several transformations and improvements can be made without departing from the idea of this application. These transformations and improvements belong to the protection scope of this application.

To make the objectives, technical solutions, and advantages of this application clearer, the following further describes this application in detail with reference to the accompanying drawings and the embodiments. It is to be understood that the specific embodiments described herein are merely used to explain this application but are not intended to limit this application.

It is to be noted that, if there is no conflict, the various features in the embodiments of this application may be combined with each other, and all fall within the scope of protection of this application. In addition, although the functional modules are divided in the schematic diagram of the apparatus, and the logical order is shown in the flowchart, in some cases, the steps shown or described may be performed in a different order from the module division in the apparatus or the order in the flowchart. In addition, the words “first”, “second”, “third”, and the like used herein do not limit the data and execution order, but only distinguish the same or similar items with substantially the same functions and effects.

Unless otherwise defined, meanings of all technical and scientific terms used in this specification are the same as that usually understood by a person skilled in the art to which this application belongs. In this specification, terms used in the specification of this application are merely intended to describe objectives of the specific embodiments, but are not intended to limit this application. A term “and/or” used in this specification includes any or all combinations of one or more related listed items.

In addition, technical features involved in implementations of this application that are described below may be combined with each other provided that no conflict occurs.

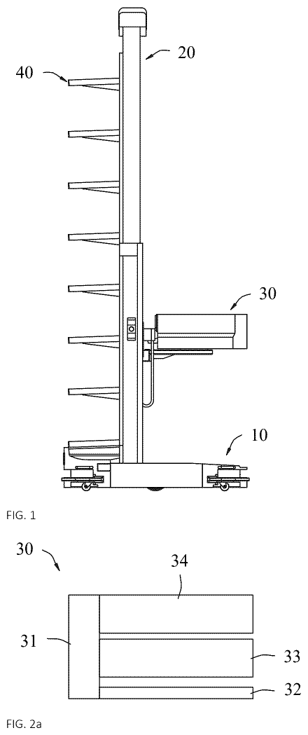

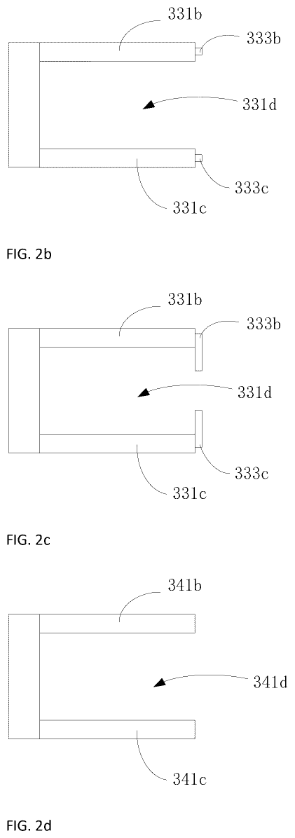

As shown in FIG. 1 and FIG. 2, a transport robot according to an embodiment of the present disclosure may include a movable base 10, a storage shelf 20 (also called as a frame), and a fork 30. The storage shelf 20 is vertically disposed on the movable base 10, and the fork 30 is disposed on one side of the storage shelf 20 and is capable of moving up and down in a height direction of the storage shelf 20, to achieve transferring and positioning at different heights.

The movable base 10 serves as a support bottom portion of the transport robot, to achieve moving and stabilization of the entire transport robot. The storage shelf 20 is vertically arranged on the movable base 10 relative to the movable base 10, and is configured to store goods. The stored goods includes, but is not limited to, at least one of containers such as goods boxes and shoe boxes. The storage shelf 20 is provided with a plurality of storage units 40 arranged at intervals from top to bottom, which are respectively configured to place containers such as goods boxes and shoe boxes, to achieve multi-level placement of goods in the height direction of the storage shelf 20.

The storage shelf 20 has two opposite sides, the storage units 40 are located on one side, and the fork 30 is located the other side. The fork 30 is capable of moving up and down in the height direction of the storage shelf 30, and is capable of receiving goods obtained from the outside (for example, a fixed shelf), and placing the obtained goods on the storage units 40 of different heights separately.

It may be understood that, corresponding to the up and down movement of the fork 30, the transport robot further includes a lifting mechanism (not shown). The lifting mechanism is disposed on the storage shelf 20 and the fork 30, and drives the fork 30 to move up and down (that is, lifting movement) in the height direction of the storage shelf 20. In an optional embodiment, the lifting mechanism may include a lifting power source and a lifting transmission assembly. The lifting power source and the lifting transmission assembly are disposed on the storage shelf 20. The lifting transmission assembly is in transmission connection with the fork 30 and the lifting power source. The lifting power source outputs power, and drives the fork 30 to move up and down through transmission of the lifting transmission assembly. A power output form of the lifting power source may be, but is not limited to, rotation, linear movement, or the like.

Further, the transport robot may further include a rotation mechanism or a translation mechanism (not shown), to drive the fork 30 to rotate or translate in the horizontal direction relative to containers on the storage shelf 20 and the fixed shelf, so as to adjust an angle according to a direction of an external goods.

Specific arrangements of the movable base 10, the storage shelf 20, the lifting mechanism, and the rotation mechanism in the transport robot of the present disclosure can refer to the corresponding structures in the patent CN212244811U, which are not be repeated herein.

In particular, the fork 30 of the present disclosure includes at least a fork body (also named as a main body) 31, a tray 32, a first fork arm 33 (also named as a first arm assembly), and a second fork arm 34 (also named as a second arm assembly), which are retractable separately. The fork 30 is disposed on the storage shelf 20 through the fork body 31. The tray 32, the first fork arm 33, and the second fork arm 34 are arranged at intervals from bottom to top and are disposed on a side of the fork body 31 facing away from the storage shelf 20. The tray 32, the first fork arm 33, and the second fork arm 34 are separately retractable in the horizontal direction relative to the fork body 31, that is, the retractable directions are perpendicular to the height direction of the fork body 31, and the retractable directions of the tray 32, the first fork arm 33, and the second fork arm 34 are consistent with a goods retrieving direction.

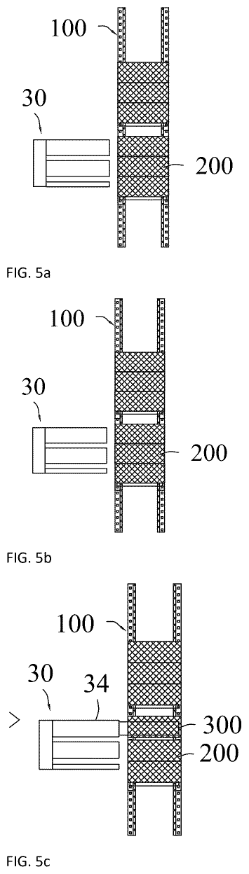

Specifically, as shown in FIG. 2 to FIG. 4, the tray 32 serves as an abutting structure at the bottom of the fork 30, and configured to, when the first fork arm 33 clamps the goods, abut another goods or structure below the goods. The tray 32 can also serve as a carrying part of the fork 30, and configured to carry goods in the fork 30. By the retractable arrangement of the tray 32, when the fork 30 retrieves goods from the fixed shelf, the tray 32 may extend to abut against another goods or structure below the target goods while supporting the target goods, so as to maintain the lower goods stable and unmoved when the upper goods are taken away.

In combination with the function and retractable arrangement of the tray 32, the tray 32 may include at least two supporting plates which are stacked up and down and capable of moving relative to each other. For example, two supporting plates are used, respectively, a first supporting plate and a second supporting plate. The first supporting plate is horizontally disposed, and one end of the first supporting plate is fixedly connected to the fork body 31. The second supporting plate is parallel to the first supporting plate and is movably placed above the first supporting plate. A guide rail structure is arranged between the first supporting plate and the second supporting plate. The second supporting plate is capable of moving back and forth in the horizontal direction relative to the first supporting plate along the guide rail structure, and moving away from or towards the fork body 31. A retractable length of the tray 32 can be adjusted through a moving distance of the second supporting plate relative to the first supporting plate.

The first fork arm 33 and the second fork arm 34 are sequentially located above the tray 32, and can be configured to clamp the goods, separately. Optionally, the first fork arm 33 may include two oppositely arranged first retractable arms 331. The two first retractable arms 331 are parallel to each other. One end of each first retractable arm 331 is disposed on the fork body 31, and the other end thereof extends in a direction away from the fork body 31. Each first retractable arm 331 may be formed by connecting two or more arm sections 331a in a movable folding manner. The two first retractable arms 331, in some embodiments, could also be named as a first arm 331b and a second arm 331c, separately, which is shown in FIG. 2a.

Further, the two first retractable arms 331 are capable of horizontally opening or closing relative to the fork body 31, to clamp the goods. When clamping the goods from the fixed shelf, the two first retractable arms 331 respectively extend into the fixed shelf to two opposite sides of the target goods; and after being in place, the two first retractable arms 331 move towards each other to close to clamp the target goods. After clamping the target goods, the two first retractable arms 331 may retract simultaneously to take the target goods out of the fixed shelf and into the fork 30; and after being in place, the two first retractable arms 331 move away from each other to open, to release clamping of the target goods, so that the target goods can be lowered and placed onto the tray 32.

Optionally, the first fork arm 33 may alternatively be a pull-type fork arm, that is, front ends of each retractable arm 331 of the first fork arm 33 is attached with a pull rod (also named as a rod) assembly, for example, a finger-shaped pull rod assembly. When retrieving the goods, the retractable arm 331 extends over a back end of a container/goods to be taken, the finger-shaped pull rod assembly rotates and lays down, hooks the back end of the container/goods, and pulls out the container/goods to be taken, to complete the goods retrieving. Such the pull-type goods retrieving structure and method are generally applicable to a situation where upper and lower surfaces of stacked containers/goods are relatively flat and there are no fasteners between the upper and lower containers/goods. In some embodiment, as shown in FIGS. 2a and 2b, the rod includes a first rod 333b and a second rod 333c. The first arm 331b is provided with the firs rod 333b, and the second arm 331c is provided with the second rod 333c.

Optionally, the second fork arm 34 may include two oppositely arranged second retractable arms 341. The two second retractable arms 341 are parallel to each other. One end of each second retractable arm 341 is disposed on the fork body 31, and the other end thereof extends in a direction away from the fork body 31. Each second retractable arm 341 may be formed by connecting two or more arm sections 341a in a movable folding manner. The two second retractable arms 341, in some embodiments, could also be named as a third arm 341b and a fourth arm 341c, separately, which is shown in FIG. 2c.

Similarly, to the first fork arm 33, the two second retractable arms 341 are capable of horizontally opening or closing relative to the fork body 31, to clamp and hold goods. When clamping the goods from the fixed shelf, the two second retractable arms 341 respectively extend into the fixed shelf to two opposite sides of the target goods; and after being in place, the two second retractable arms 341 move towards each other to close to hold the target goods. After holding the target goods, the two second retractable arms 341 may retract simultaneously to take the target goods out of the fixed shelf and into the fork 30; and after being in place, the two second retractable arms 341 move away from each other to open, to release clamping of the target goods, so that the target goods can be lowered and placed onto the tray 32.

According to arrangements of the sizes of the first fork arm 33 and the second fork arm 34 and clamping forces thereof, when the first fork arm 33 clamps the target goods, the clamped target goods may be one or more goods stacked up and down. For the plurality of goods stacked up and down, the first fork arm 33 mainly clamps the goods located at a bottom portion. Similarly, the target goods clamped by the second fork arm 34 may be one or more goods stacked up and down. For the plurality of goods stacked up and down, the second fork arm 34 mainly clamps the goods located at a bottom portion.

For retractable performance of the tray 32, the first fork arm 33, and the second fork arm 34, the tray 32, the first fork arm 33, and the second fork arm 34 may be driven by driving mechanisms thereof respectively to extend or retract. The driving mechanism may include a driving motor, a chain wheel assembly, a belt wheel assembly, or the like. The chain wheel assembly and the belt wheel assembly are matched with the driving motor. Alternatively, the driving mechanism may include a cylinder, or the like, and can be implemented by an existing driving technique.

The performance of opening or closing of the first retractable arm 331 and the performance of opening or closing of the second retractable arm 341 are respectively driven through coordination of respective guide rail and driving assembly. For example, for the two first retractable arms 331, corresponding positions of the fork body 31 are provided with transversely arranged guide rails. Length directions of the guide rails are parallel to folding and unfolding directions of the two first retractable arms 331. One ends of the two first retractable arms 331 can be slidably fitted on the guide rails along the guide rails. The two first retractable arms 331 are connected and driven to move towards or away from each other along the guide rails by motors. The performance of opening or closing of the two second retractable arms 341 is similar to the performance of opening or closing of the two first retractable arms 331.

When the transport robot of the present disclosure is applied to retrieve goods, goods stacked at any position, for example, a top level, a middle level, or a bottom level, can be retrieved from the fixed shelf.

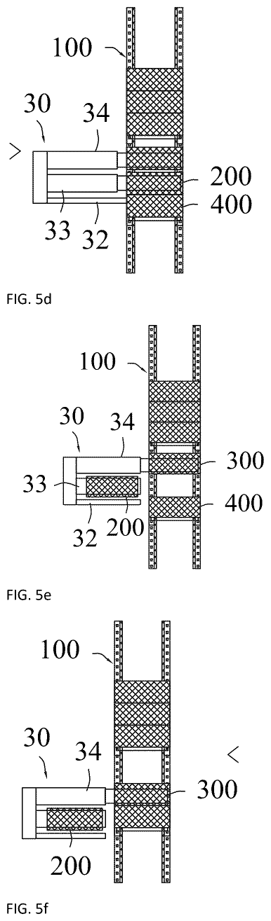

Correspondingly, in an embodiment, the goods retrieving method for the transport robot of the present disclosure includes retrieving a target goods stacked at the middle or lower level from the fixed shelf. Referring to FIG. 5, the retrieving a target goods stacked at a middle or lower level from a fixed shelf includes the following operations.

In block S1.1: Before a transport robot moves to a fixed shelf 100, a fork 30 of the transport robot moves to a height of a target goods 200, as shown in FIG. 5(a).

Generally, the fixed shelf 100 is provided with a plurality of partition boards arranged at intervals from top to bottom, and one goods or a plurality of goods stacked up and down can be stacked on a placement position of each partition board. The target goods 200 in this embodiment may be goods placed on any partition board, and is goods in a middle level or a lower level among a plurality of goods stacked up and down. The target goods 200 in the middle level means that there are goods stacked on and below the target goods 200, the number of goods on the target goods is not limited to one, and the number of goods below the target goods is not limited to one. The target goods 200 at a lower level means that a position above the target goods 200 is stacked with goods, and a position below the target goods 200 is a shelf support surface of a partition board of the fixed shelf 100, that is, a carrying surface of the partition board. The number of the foregoing target goods 200 is not limited to one. The target goods may be a group of goods formed by stacking two or more goods up and down.

Movement of the transport robot mainly includes controlling, by a control system, a movable base 10 of the transport robot to move to the front of the fixed shelf 100 according to a preset path, and then controlling, by the control system, the lifting mechanism to drive the fork 30 to move up and down to a required height.

In block S1.2: A second fork arm 34 of the fork 30 extends to clamp and lift goods 300 stacked on the target goods 200, separating the goods 300 from contact with the target goods 200, as shown in FIG. 5(b) to FIG. 5(c).

In combination with FIG. 1 and FIG. 5(b) to FIG. 5(c), step S1.2 specifically includes the following steps: After the second fork arm 34 clamps the goods 300, the fork 30 moves upwards along a height of the storage shelf 10 of the transport robot and drives the goods 300 clamped by the second fork arm 34 to move upwards, separating the goods 300 from contact with the target goods 200.

A distance by which the fork 30 moves upwards is less than a height of the target goods 200, so that after the second fork arm 34 clamps the goods 300 to separate the goods from contact with the target goods 200, the target goods 200 is still within a clamping area of the first fork arm 33. In some embodiments, when the clamped goods 300 is moved upwards, it is only necessary to separate a contact surface of the goods 300 from a contact surface of the target goods 200, such that the goods 300 is no longer supported by the target goods 200.

In block S1.3: The first fork arm 33 and the tray 32 on the fork 30 extend separately, the first fork arm 33 clamps the target goods 200, and the tray 32 extends to a position in front of the goods under the target goods 200 to abut against the goods, as shown in FIG. 5(d).

According to an actual operation, the first fork arm 33 and the tray 32 may extend simultaneously, or the first fork arm 33 extends first and then the tray 32 extends, or the tray 32 extends first and then the first fork arm 33 extends.

When the target goods 200 is stacked in the middle, the tray 32 extends and then abuts against another goods 400 below the target goods 200. When the target goods 200 is stacked at a lower level, the tray 32 extends and then abuts against the partition board below the target goods 200.

In the embodiment shown in FIG. 5, three goods are stacked at each partition board of the fixed shelf 100 from bottom to top, and the second fork arm 34 in the fork 30 clamps an uppermost goods 300 and lifts the uppermost goods 300, so as to separate the uppermost goods 300 from contact with a middle target goods 200. Then, the first fork arm 33 clamps the middle target goods 200, and the tray 32 abuts against a lowermost goods 400.

It may be understood that when the target goods 200 is a lowermost goods, for the case in which three goods are stacked at one partition board from bottom to top, the second fork arm 34 in the fork 30 clamps the middle goods, to lift the middle goods and the goods stacked thereon upwards together to separate the middle goods from contact with the lowermost goods. Then, the first fork arm 33 clamps the lowermost goods, and the tray 32 abuts against the partition board below the lowermost goods.

In block S1.4: The first fork arm 33 and the tray 32 retract separately, to take the target goods 200 out of the fixed shelf 100 and place the target goods 200 in the fork 30, as shown in FIG. 5(e).

In block S1.5: The fork 30 descends, the second fork arm 34 retracts after lowering and placing the clamped goods 300, as shown in FIG. 5(f) to FIG. 5(g).

Specifically, in the operation in block S1.5, after the fork 30 descends and drives the second fork arm 34 to descend the goods 300 clamped by the fork 30 to the original position of the target goods 200 on the fixed shelf 100, the second fork arm 34 releases clamping of the goods 300, so that the goods 300 originally above the target goods 200 is placed in the original position of the target goods 200, and then the second fork arm 34 retracts away from the fixed shelf 100.

Through the foregoing operations, retrieving of goods in the middle on the fixed shelf 100 is implemented. The fork 30 then transfers the retrieved target goods 200 to the storage shelf 10 of the transport robot, and then retrieves a next target goods 200 from the fixed shelf 100 or ends the operation.

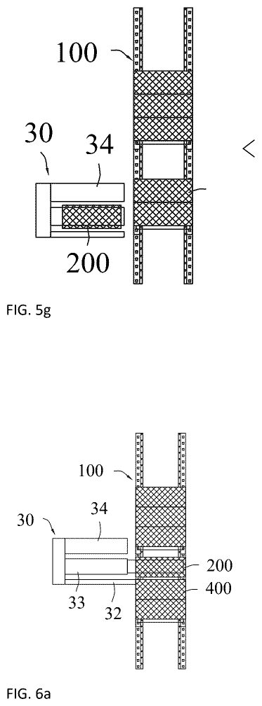

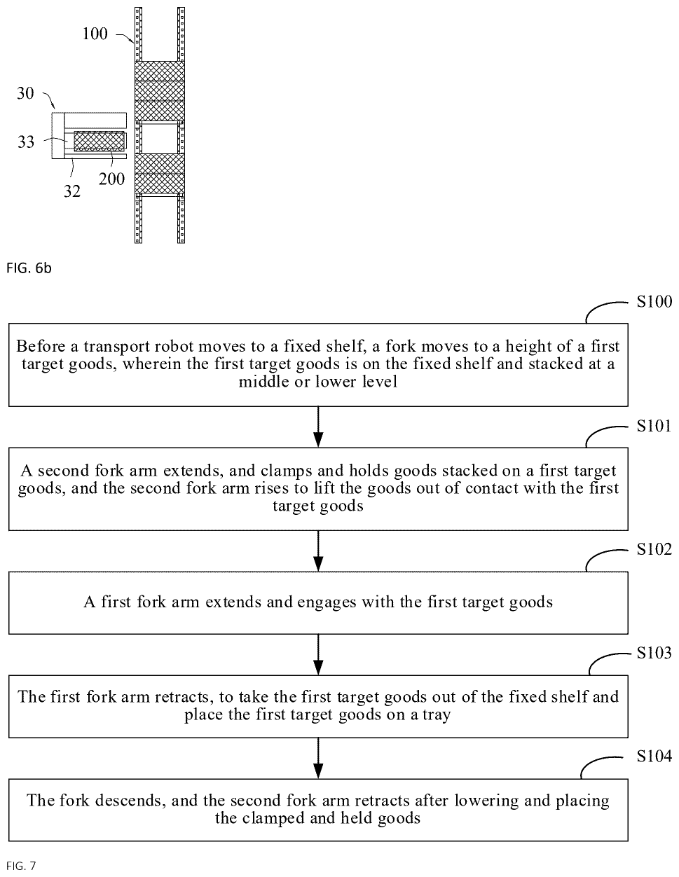

In another embodiment of the goods retrieving method for by the transport robot of the present disclosure, the method further includes retrieving a target goods stacked at an upper level from a fixed shelf. Referring to FIG. 6, the retrieving a target goods stacked at an upper level from a fixed shelf may include the following operations:
S2.1: In front of a fixed shelf 100, a fork 30 on the transport robot moves to a height of a target goods 200, as shown in FIG. 6(a).

The transport robot mainly controls, by a control system, a movable base 10 of the transport robot to move to the front of the fixed shelf 100 according to a preset path, and then controls, by the control system, the lifting mechanism to drive the fork 30 to move up and down to a required height.
S2.2: A first fork arm 33 and a tray 32 on the fork 30 extend respectively, the first fork arm 33 clamps the target goods 200 located on the top level, and the tray 32 extends and abuts against another goods 400 below the target goods 200, as shown in FIG. 6(a).

According to an actual operation, the first fork arm 33 and the tray 32 may extend simultaneously, or the first fork arm 33 extends first and then the tray 32 extends, or the tray 32 extends first and then the first fork arm 33 extends.

The number of the foregoing target goods 200 is not limited to one. Alternatively, the foregoing target goods 200 may be a group of goods formed by stacking two or more goods up and down.

In the embodiment shown in FIG. 6, three goods are stacked at each partition board of the fixed shelf 100 from bottom to top, and the second fork arm 34 of the fork 30 does not need to operate, and maintain an initial retracted state. The first fork arm 33 extends to two opposite sides of the uppermost target goods 200 to clamp the target goods 200. The tray 32 extends and abuts against a middle goods 400.
S2.3: The first fork arm 33 and the tray 32 retract respectively, to retrieve the target goods 200 out of the fixed shelf 100 and place the target goods in the fork 30, as shown in FIG. 6(a) to FIG. 6(b).

Further, the target goods 200 may alternatively be placed on the tray 32 to form a stable support for the target goods 200.

Through the foregoing operations, retrieving of the goods at the upper level on the fixed shelf 100 is completed. The fork 30 then transfers the taken target goods 200 to the storage shelf 10 of the transport robot, and then retrieves a next target goods 200 from the fixed shelf 100 or ends the operation.

In the entire goods retrieving process, the goods retrieving methods according to the two embodiments shown in FIG. 5 and FIG. 6, or only according to any one of the embodiments can be performed, and specific operations are carried out flexibly according to actual quantities and positions of goods to be taken.

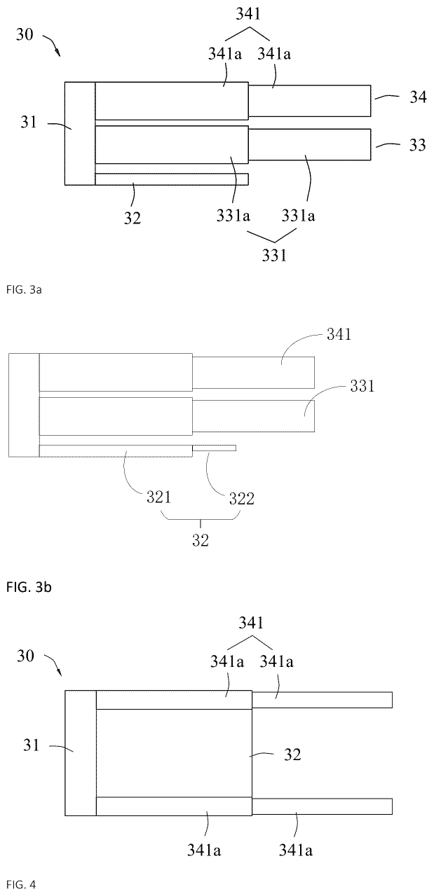

In some embodiments, as shown in FIG. 2 and FIG. 3a, a fork for a transport robot may include a fork body 31 and a tray 32, a first fork arm 33, and a second fork arm 34 arranged on the fork body 31. The first fork arm 33 is located above the tray 32 and is retractable relative to the fork body 31. The first fork arm 33 is configured to transport goods. The second fork arm 34 is located above the first fork arm 33 and is retractable relative to the fork body 31. The second fork arm 34 is configured to carry goods. Retractable directions of the first fork arm 33 and the second fork arm 34 are the same.

In some embodiments, the tray 32, the first fork arm 33, and the second fork arm 34 are sequentially arranged on the fork body 31 from bottom to top in a vertical direction, and the retractable directions of the first fork arm 33 and the second fork arm 34 are a first horizontal direction.

In some embodiments, the first fork arm 33 includes two oppositely arranged first retractable arms 331, where the two first retractable arms 331 are capable of opening or closing in a second horizontal direction, to release or clamp goods. The second horizontal direction is perpendicular to the first horizontal direction. Alternatively, a pull rod assembly is provided at one end of each first retractable arm 331, away from the fork body 31, and the pull rod assembly is configured to pull goods onto the tray 32.

In some embodiments, the second fork arm 34 includes two oppositely arranged second retractable arms 341, where the two second retractable arms 341 are capable of opening or closing in a second horizontal direction, to release or clamp and hold goods. The second horizontal direction is perpendicular to the first horizontal direction.

In some embodiments, as shown in FIG. 5, the second fork arm 34 is configured to carry goods 300 on the first target goods 200, to separate the goods 300 from contact with the target goods 200. The first fork arm 33 is configured to carry the first target goods 200 onto the tray 32 after the second fork arm 34 carries the goods 300 above the first target goods 200 to separate the goods 300 from contact with the first target goods 200.

In some embodiments, the tray 32 is retractably connected to the fork body 31, and a retractable direction of the tray 32 and the retractable direction of the first fork arm 33 are the same.

In some embodiments, the tray 32 includes a first supporting plate 321 and a second supporting plate 322, as shown in FIG. 3b. One end of the first supporting plate 321 is connected to the fork body 31. The second supporting plate 322 is movably disposed on the first supporting plate 321 and is capable of moving relative to the first supporting plate 321 in the horizontal direction.

In some embodiments, a transport robot includes a movable base, a storage shelf 10, and the fork 30. The storage shelf 10 is vertically arranged on the movable base, and the fork 30 is arranged on one side of the storage shelf 10 and is capable of moving up and down along a height of the storage shelf 10.

In some embodiments, a goods retrieving method for the foregoing transport robot includes the following operations.
S100: Before a transport robot moves to a fixed shelf, a fork moves to a height of a first target goods, where the first target goods is on the fixed shelf and stacked at a middle or lower level.
S101: A second fork arm extends and clamps goods stacked on the first target goods, and the second fork arm lifts the goods stacked on the first target goods, separating the goods from contact with the first target goods.
S102: A first fork arm extends and engages with the first target goods.
S103: The first fork arm retracts, to take the first target goods out of the fixed shelf and place the first target goods on a tray.
S104: The fork descends, and the second fork arm retracts after lowering and placing the clamped goods.

In some embodiments, in operation S101, after the second fork arm clamps the goods, the fork moves upwards along a height of the storage shelf of the transport robot and drives the goods clamped by the second fork arm to move upwards, so as to separate the goods from contact with the first target goods.

In some embodiments, a distance by which the fork moves upwards is less than the height of the first target goods, so that after the second fork arm clamps the goods and separates the goods from contact with the first target goods, the first target goods is still within a clamping area of the first fork arm.

In some embodiments, in operation S102, the first fork arm may be the foregoing clamp-type fork arm, that is, the two first retractable arms may open or close in the second horizontal direction, and the first fork arm extends and then clamps the first target goods.

In some embodiments, operation S102 further includes: the tray extending relative to the fork body.

In some embodiments, when the first target goods is stacked in the middle, the tray extends and abuts against another goods below the first target goods. When the first target goods is stacked at a lower level, the tray extends and abuts against a partition board below the first target goods.

In some embodiments, in operation S104, after the fork descends and drives the second fork arm to descend the goods clamped by the fork to an original position of the first target goods on the fixed shelf, the second fork arm releases clamping of the goods and retracts.

In some embodiments, the goods retrieving method further includes: in front of a fixed shelf, a fork moving to a height of a second target goods, where the second target goods are on the fixed shelf and stacked at an upper level; the first fork arm extending and clamping the second target goods; and the first fork arm retracting to take the second target goods out of the fixed shelf and place the second target goods on the tray.

It may be understood that, for the fork 30 in the present disclosure, the second fork arm 34 and the first fork arm 33 are arranged at an interval up and down and can independently perform retractable actions, so as to implement flexible scheduling of the two fork arms, so that goods at any level on the shelf can be taken and placed, which is suitable for retrieving and placing goods stacked at a single level and is also suitable for retrieving and placing goods stack in multiple levels.

In some embodiments, a transport robot of the present disclosure may include a movable base 10, a frame 20 arranged on the movable base 10, a first arm assembly 33 and a second arm assembly 34. The first arm assembly 33 is arranged on the frame 20. The first arm assembly 33 is movable vertically along the frame 20 and retractable horizontally relative to the frame 20. The first arm assembly 33 is configured to carry a first container. The second arm assembly 34 is arranged on the frame 20 and located above the first arm assembly 33. The second arm assembly 34 is movable vertically along the frame 20 and retractable horizontally relative to the frame 20. The second arm assembly 34 is configured to move a second container.

In some embodiments, when the second container is stacked on the first container, and the first container needs to be retrieved, the second arm assembly 34 is configured to move the second container to separate the second container from the first container, and the first arm assembly 33 is configured to carry the first container after the second container is separated from the first container.

In some embodiments, as shown in FIG. 2a-2b, the first arm assembly 33 includes a main body 31, a first arm 331b and a second arm 331c. The first arm 331b is connected to an end of the main body 31. The first arm 331b is retractable relative to the main body 31 in a first direction. The second arm 331c is connected to the other end of the main body 20 and opposite to the first arm 331b. The second arm 331c is retractable relative to the main body 31 in the first direction. The first arm 331b and the second arm 331c are on a same horizontal plane, a space 331d between the first arm 331b and the second arm 331c is configured to accommodate the first container when the first arm 331b and the second arm 331c are carrying the first container.

In some embodiments, the first arm 331b is movably connected to the main body 31, and is capable of moving towards or away from the second arm 331c in a second direction. The second arm 331c is movably connected to the main body 20, and is capable of moving towards or away from the first arm 331b in the second direction. When the first arm 331b and the second arm 331c move towards each other, the first arm 331b and the second arm 331c are configured to clamp the first container. The first direction is perpendicular to the second direction.

In some embodiments, the first arm 331b is provided with a first rod 333b, and the second arm 331c is provided with a second rod 333c. The first rod 333b and the second rod 333c are configured to act on a surface of the container to move the container.

In some embodiments, the first rod 333b is movably connected to the first arm 331b, the second rod 331c is movably connected to the second arm 333c. Each of the first rod 333b and the second rod 333c is configured to switch between a first state and a second state. When in the first state, the first rod 333b is folded relative to the first arm 331b, and when in the second state, the first rod 333b is unfolded relative to the first arm 331b and protruded from the first arm 331b towards the second arm 331c. When in the first state, the second rod 333c is folded relative to the second arm 331c, and when in the second state, the second rod 333c is unfolded relative to the second arm 331c and protruded from the second arm 331c towards the first arm 331b.

In some embodiments, the second arm assembly 34 includes a third arm 341b and a fourth arm 341c arranged opposite to the third arm 341b. Both the third arm 341b and the fourth arm 341c are retractable in a first direction. The third arm 341b and the fourth arm 341c are on a same horizontal plane, a space 341d between the third arm 341b and the fourth arm 341c is configured to accommodate the second container when the third arm 341b and the fourth arm 341c are carrying the second container.

In some embodiments, the third arm 341b and the fourth arm 341c are movable arranged on the frame 20, and capable of moving towards each other in a second direction to clamp the second container, or moving away from each other in the second direction to release the second container.

In some embodiments, the transport robot further includes a tray 32 arranged on the frame 20 and located under the first arm assembly 33. The tray 32 is retractable horizontally relative to the frame 20. The tray 32 is configured to abut against an object under the first container when the first arm assembly 33 is carrying the first container, and support the first container after the first container is retrieved by the first arm assembly 33.

In some embodiments, the tray 32 includes a first supporting plate 321 and a second supporting plate 322, one end of the first supporting plate 321 is connected to the frame 20, and the second supporting plate 322 is movably arranged on the first supporting plate 321 and is capable of moving relative to the first supporting plate 321. The retractable directions of the first arm assembly 33, the second arm assembly 34 and the tray 32 are the same.

In some embodiments, a transport robot of the present disclosure may include a movable base 10, a frame 20 arranged on the movable base 10, a first fork arm 33 arranged on the frame 20 and a second fork arm 34 arranged on the frame 20 and located above the first fork arm 33. The first fork arm 33 is retractable relative to the frame 20 and capable of moving up or down along the frame 20. The second fork 34 arm is retractable relative to the frame 20 and capable of moving up or down along the frame 20. A retractable direction of the first fork arm 33 is consistent with a retractable direction of the second fork arm 34. The second fork arm is configured to carry goods stacked on a target goods, to separate the goods from contact with the target goods. The first fork arm 33 is configured to retrieve the target goods after the second fork arm separate the goods stacked on the target goods from the target goods.

In some embodiments, the retractable direction of the first fork arm 33 is a first horizontal direction. The first fork arm 33 includes two oppositely arranged first retractable arms 331, the two first retractable arms 331 are capable of opening or closing in a second horizontal direction to release or clamp the target goods. The second horizontal direction is perpendicular to the first horizontal direction.

In some embodiments, the first fork arm 33 includes two oppositely arranged first retractable arms 331. A rod 333b, 333c is provided at each first retractable arm 33. The rod 333b, 333c is configured to act on a surface of the target goods to move the target goods.

In some embodiments, the second fork arm 34 includes two oppositely arranged second retractable arms 341, wherein the two second retractable arms 341 are capable of opening or closing in a second horizontal direction, to release or clamp the goods. The second horizontal direction is perpendicular to the first horizontal direction.

In some embodiments, the transport robot further includes a tray 32 retractably connected to the frame 20 and located under the first fork arm 33. A retractable direction of the tray 32 is consistent with the retractable direction of the first fork arm 33.

In some embodiments, the tray 32 includes a first supporting plate 321 and a second supporting plate 322. One end of the first supporting plate 321 is connected to the frame 20, and the second supporting plate 322 is movably arranged on the first supporting plate 321 and is capable of moving relative to the first supporting plate 321 in the horizontal direction.

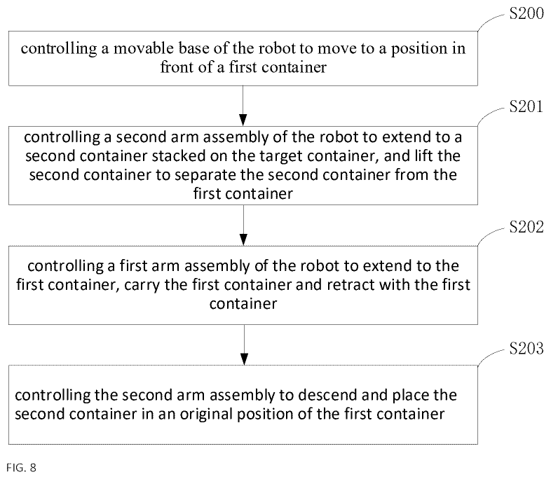

As shown in FIG. 8, a method for controlling a robot to retrieve goods, which is executable by a controlling system, includes the following operations.

In block S200, a movable base of the robot is controlled to move to a position in front of a first container.

In block S201, a second arm assembly of the robot is controlled to extend to a second container stacked on the target container, and lift the second container to separate the second container from the first container.

In block S202, a first arm assembly of the robot is controlled to extend to the first container, carry the first container and retract with the first container.

In block S203, the second arm assembly is controlled to descend and place the second container in an original position of the first container.

In some embodiments, the operation of the first arm assembly of the robot being controlled to extend to the first container, carry the first container and retract with the first container includes: a first arm of the first arm assembly is controlled to extend to a first side of the first container; a second arm of the first arm assembly is controlled to extend to a second side of the first container, wherein the second side is opposite to the first side; a first rod provided on the first arm is controlled to switch from a first state to a second state, in which the first rod is protruded from the first arm towards the second arm, to carry the first container; a second rod provided on the second arm is controlled to switch from the first state, in which the second rod is protruded from the second arm towards the first arm, to the second state to carry the first container; and the first arm and the second arm are controlled to retract with the first rod and the second rod carrying the first container.

In some embodiments, the operation of the first arm assembly of the robot being controlled to extend to the first container, carry the first container and retract with the first container includes: a first arm of the first arm assembly is controlled to extend to a first side of the first container; a second arm of the first arm assembly is controlled to extend to a second side of the first container that is opposite to the first side; the first arm and the second arm are controlled to move towards each other to clamp the first container; the first arm and the second arm are controlled to retract with clamping the first container.

In some embodiments, before the operation of the first arm assembly of the robot being controlled to retract with the first container, the method further includes: a tray of the robot, which is arranged under the first arm assembly, is controlled to extend to an object under the first container and abut against the object. After the operation of the first arm assembly of the robot being controlled to retract with the first container, the method further includes: the first arm assembly is controlled to place the first container on the tray.

In combination with the foregoing arrangement of the fork arms on the fork 30 and the goods retrieving method, a third fork arm, a fourth fork arm, and the like may be added to the fork 30 in the height direction according to requirements, so as to implement clamping of a plurality of goods at a time, or the like.

Finally, it is to be noted that, the foregoing embodiments are merely used to describe the technical solutions of this application, but are not intended to limit this application. Under the ideas of this application, the technical features in the foregoing embodiments or different embodiments may alternatively be combined, the steps may be performed in any order, and many other changes of different aspects of this application also exists as described above, and these changes are not provided in detail for simplicity. Although this application is described in detail with reference to the foregoing embodiments, it should be appreciated by a person skilled in the art that, modifications may still be made to the technical solutions described in the foregoing embodiments, or equivalent replacements may be made to the part of the technical features; and these modifications or replacements do not cause the essence of corresponding technical solutions to depart from the scope of the technical solutions in the embodiments of this application.

1. A transport robot, comprising:
a movable base;
a frame arranged on the movable base;
a first arm assembly arranged on the frame, wherein the first arm assembly is movable vertically along the frame and retractable horizontally relative to the frame, and the first arm assembly is configured to carry a first container; and
a second arm assembly arranged on the frame and located above the first arm assembly, wherein the second arm assembly is movable vertically along the frame and retractable horizontally relative to the frame, and the second arm assembly is configured to move a second container.

2. The transport robot according to claim 1, wherein when the second container is stacked on the first container, and the first container needs to be retrieved, the second arm assembly is configured to move the second container to separate the second container from the first container, and the first arm assembly is configured to carry the first container after the second container is separated from the first container.

3. The transport robot according to claim 1, wherein the first arm assembly comprises:
a main body connected to the frame, wherein the main body is capable of moving in a vertical direction along the frame;
a first arm connected to an end of the main body, wherein the first arm is retractable relative to the main body in a first direction; and
a second arm connected to the other end of the main body and opposite to the first arm, wherein the second arm is retractable relative to the main body in the first direction;
wherein the first arm and the second arm are on a same horizontal plane, a space between the first arm and the second arm is configured to accommodate the first container when the first arm and the second arm are carrying the first container.

4. The transport robot according to claim 3, wherein the first arm is movably connected to the main body, and is capable of moving towards or away from the second arm in a second direction;
wherein the second arm is movably connected to the main body, and is capable of moving towards or away from the first arm in the second direction;
wherein when the first arm and the second arm move towards each other, the first arm and the second arm are configured to clamp the first container; and
wherein the first direction is perpendicular to the second direction.

5. The transport robot according to claim 3, wherein the first arm is provided with a first rod, and the second arm is provided with a second rod;
wherein the first rod and the second rod are configured to act on a surface of the container to move the container.

6. The transport robot according to claim 5, wherein the first rod is movably connected to the first arm, the second rod is movably connected to the second arm;
wherein each of the first rod and the second rod is configured to switch between a first state and a second state;
wherein when in the first state, the first rod is folded relative to the first arm, and when in the second state, the first rod is unfolded relative to the first arm and protruded from the first arm towards the second arm; and
wherein when in the first state, the second rod is folded relative to the second arm, and when in the second state, the second rod is unfolded relative to the second arm and protruded from the second arm towards the first arm.

7. The transport robot according to claim 1, wherein the second arm assembly comprises:
a third arm, and
a fourth arm arranged opposite to the third arm;
wherein both the third arm and the fourth arm are retractable in a first direction, the third arm and the fourth arm are on a same horizontal plane, a space between the third arm and the fourth arm is configured to accommodate the second container when the third arm and the fourth arm are carrying the second container.

8. The transport robot according to claim 7, wherein the third arm and the fourth arm are movable arranged on the frame, and capable of moving towards each other in a second direction to clamp the second container, or moving away from each other in the second direction to release the second container;
wherein the first direction is perpendicular to the second direction.

9. The transport robot according to claim 1, further comprising a tray arranged on the frame and located under the first arm assembly, the tray is retractable horizontally relative to the frame;
wherein the tray is configured to abut against an object under the first container when the first arm assembly is carrying the first container, and support the first container after the first container is retrieved by the first arm assembly.

10. The transport robot according to claim 9, wherein the tray comprises a first supporting plate and a second supporting plate, one end of the first supporting plate is connected to the frame, and the second supporting plate is movably arranged on the first supporting plate and is capable of moving relative to the first supporting plate;
wherein the retractable directions of the first arm assembly, the second arm assembly and the tray are the same.

11. A transport robot, comprising:
a movable base;
a frame arranged on the movable base;
a first fork arm arranged on the frame, wherein the first fork arm is retractable relative to the frame and capable of moving up or down along the frame; and
a second fork arm arranged on the frame and located above the first fork arm, wherein the second fork arm is retractable relative to the frame and capable of moving up or down along the frame;
wherein a retractable direction of the first fork arm is consistent with a retractable direction of the second fork arm;
wherein the second fork arm is configured to carry goods stacked on a target goods, to separate the goods from contact with the target goods; and
wherein the first fork arm is configured to retrieve the target goods after the second fork arm separate the goods stacked on the target goods from the target goods.

12. The transport robot according to claim 11, wherein the retractable direction of the first fork arm is a first horizontal direction;
wherein the first fork arm comprises two oppositely arranged first retractable arms, the two first retractable arms are capable of opening or closing in a second horizontal direction to release or clamp the target goods; and
wherein the second horizontal direction is perpendicular to the first horizontal direction.

13. The transport robot according to claim 11, wherein the first fork arm comprises two oppositely arranged first retractable arms, a rod is provided at each first retractable arm, and the rod is configured to act on a surface of the target goods to move the target goods.

14. The transport robot according to claim 11, wherein the second fork arm comprises two oppositely arranged second retractable arms, wherein the two second retractable arms are capable of opening or closing in a second horizontal direction, to release or clamp the goods, and the second horizontal direction is perpendicular to the first horizontal direction.

15. The transport robot according to claim 11, further comprising a tray retractably connected to the frame and located under the first fork arm;
wherein a retractable direction of the tray is consistent with the retractable direction of the first fork arm.

16. The transport robot according to claim 15, wherein the tray comprises a first supporting plate and a second supporting plate, one end of the first supporting plate is connected to the frame, and the second supporting plate is movably arranged on the first supporting plate and is capable of moving relative to the first supporting plate in the horizontal direction.

17. A method for controlling a robot to retrieve goods, executable by a controlling system, the method comprising:
controlling a movable base of the robot to move to a position in front of a first container;
controlling a second arm assembly of the robot to extend to a second container stacked on the target container, and lift the second container to separate the second container from the first container;
controlling a first arm assembly of the robot to extend to the first container, carry the first container and retract with the first container; and
controlling the second arm assembly to descend and place the second container in an original position of the first container.

18. The method according to claim 17, wherein the controlling the first arm assembly of the robot to extend to the first container, carry the first container and retract with the first container comprises:
controlling a first arm of the first arm assembly to extend to a first side of the first container;
controlling a second arm of the first arm assembly to extend to a second side of the first container, wherein the second side is opposite to the first side;
controlling a first rod provided on the first arm to switch from a first state to a second state to carry the first container, wherein when in the second state, the first rod is protruded from the first arm towards the second arm;
controlling a second rod provided on the second arm to switch from the first state to the second state to carry the first container, wherein when in the second state, the second rod is protruded from the second arm towards the first arm; and
controlling the first arm and the second arm to retract with the first rod and the second rod carrying the first container.

19. The method according to claim 17, wherein the controlling the first arm assembly of the robot to extend to the first container, carry the first container and retract with the first container comprises:
controlling a first arm of the first arm assembly to extend to a first side of the first container;
controlling a second arm of the first arm assembly to extend to a second side of the first container, wherein the second side is opposite to the first side;
controlling the first arm and the second arm to move towards each other to clamp the first container; and
controlling the first arm and the second arm to retract with clamping the first container.

20. The method according to claim 17, wherein before the controlling the first arm assembly of the robot to retract with the first container, the method comprises:
controlling a tray of the robot to extend to an object under the first container and abut against the object, wherein the tray is arranged under the first arm assembly; and
wherein after the controlling the first arm assembly of the robot to retract with the first container comprises:
controlling the first arm assembly to place the first container on the tray.
